(19) United States
(12) Patent Application Publication
(10) Pub. No.: US 2014/0224392 A1
(43) Pub. Date: Aug. 14, 2014

(54) TIRE WITH ELECTRICALLY NON-CONDUCTIVE RUBBER TREAD WITH ELECTRICALLY CONDUCTIVE, CARBON NANOTUBE CONTAINING RUBBER STRIP EXTENDING THROUGH THE TREAD TO ITS RUNNING SURFACE

(71) Applicants: Ling Du, Fairlawn, OH (US); Xiaoping Yang, Streetsboro, OH (US); Carl Trevor Ross Pulford, Akron, OH (US)

(72) Inventors: Ling Du, Fairlawn, OH (US); Xiaoping Yang, Streetsboro, OH (US); Carl Trevor Ross Pulford, Akron, OH (US)

(21) Appl. No.: 13/766,866

(22) Filed: Feb. 14, 2013

(51) Int. Cl. B60C 19/08

(52) U.S. Cl. CPC B60C 19/08
USPC 152/152.1

(57) ABSTRACT

This invention relates to a tire having a circumferential electrically non-conductive (relatively electrically non-conductive) rubber tread which contains an electrically conductive (relatively electrically conductive) rubber strip extending from an electrically conductive underlying tread base rubber layer (underlying the tread) through the rubber tread to its running surface. The rubber strip contains a dispersion of carbon nanotubes to provide its electrical conductivity and to thereby provide a path of least electrical resistance through the tread to its running surface.

### FIELD OF INVENTION

This invention relates to a tire having a circumferential electrically non-conductive (relatively electrically non-conductive) rubber tread which contains an electrically conductive (relatively electrically conductive) rubber strip extending from an electrically conductive underlying tread base rubber layer (underlying the tread) through the rubber tread to its running surface. The rubber strip contains a dispersion of carbon nanotubes to provide its electrical conductivity and to thereby provide a path of least electrical resistance through the tread to its running surface.

### BACKGROUND OF THE INVENTION

Pneumatic tires typically have a circumferential rubber tread configured with a cap/base construction. For the cap/base tread construction, the outer tread rubber cap layer contains the tread's running surface and is therefore intended to be ground contacting for the tire. The tread base rubber layer typically underlies the tread cap rubber layer. Such cap/base tread construction for a tire is well known to those having skill in such art.

In practice, the tread cap rubber layer may, in some instances, be comprised of an electrically insulating (relatively poorly electrically conductive, sometimes referred to as being electrically resistive or electrically non-conductive) rubber composition and the tread base rubber layer comprised of a rubber composition which is relatively electrically conductive (relative to the tread cap rubber layer).

In such instance, it may be desired to provide a path of least electrical resistance from the tread base rubber layer through the outer tread cap rubber layer to its running surface to aid in dissipating electrical potential from the tire.

Numerous proposals have been made for providing a path of least electrical resistance to extend from an electrically conductive tread base rubber layer through the electrically non-conductive tread cap rubber layer to its running surface. Exemplary of such proposals, which is not intended to limited of all-inclusive, is for example, U.S. Pat. No. 5,942,069.

For this invention, a departure from past practice is presented by providing an inclusion of a dispersion of electrical conductivity promoting carbon nanotubes in a carbon black deficient, precipitated silica reinforced, thin rubber strip which extends from an electrically conductive tread base rubber layer through an electrically resistive, carbon black deficient, precipitated silica reinforced, tread cap rubber layer to its running surface to provide a path of least electrical resistance through the tread cap rubber layer.

In this manner, then, the rubber compositions for both the outer tread cap rubber layer and the rubber strip are similar in a sense that they are rubber reinforcing carbon black deficient for rubber reinforcing purposes (e.g. contain less than 30 phr of rubber reinforcing carbon black) and rely on precipitated silica for their rubber reinforcement (e.g. contain at least 40 phr of precipitated silica together with silica coupler for the precipitated silica) which, in turn, because of the rubber reinforcing carbon black deficiency, promotes electrical resistivity for both of the rubber compositions.

Carbon nanotubes have heretofore been suggested for inclusion in rubber compositions, including tire treads, for various purposes. For example, and not intended to be limiting, see Patent Publications: U.S. Pat. No. 6,476,154, U.S.2006/0061011, U.S.2010/0078194, U.S.2011/0146859, WO2003/060002, DE 102007056689, JP2009/046547, KR 100635604 and KR 2005027415.

The carbon nanotubes are conventionally nano-sized particles in a sense of having an average diameter in a range of from about 1 nm to about 100 nm and an average L/D (length to diameter ratio) in a range of from about 10/1 to about 10,000/1.

Such carbon nanotubes are conventionally prepared by, for example, by passing a gaseous carbon-containing compound such as for example, at least one of acetylene and ethanol, usually contained in nitrogen or hydrogen through or over a heated catalyst (e.g. heated to about 700° C.) of metal nanoparticles. Carbon deposited on the metallic nanoparticles is a form of the carbon nanotubes is recovered.

In the description of this invention, the term “phr” is used to refer to parts by weight of a material per 100 parts by weight of elastomer. The terms “rubber” and “elastomer” may be used interchangeably unless otherwise indicated. The terms “vulcanized” and “cured” may be used interchangeably, as well as “unvulcanized” or “uncured”, unless otherwise indicated.

### SUMMARY AND PRACTICE OF THE INVENTION

In accordance with this invention, a tire is provided having a circumferential rubber tread of a cap/base construction where said tread cap rubber layer is an outer tread rubber layer with a running surface for the tire and where said tread base rubber layer underlies said tread cap rubber layer;

wherein said rubber tread is comprised of an outer tread cap rubber layer with a tread running surface (intended to be ground-contacting) composed of an electrically resistive (relatively electrically non-conductive) rubber composition which contains a electrically conductive thin rubber strip extending radially outward from an underlying tread base rubber layer through the outer tread cap rubber layer to its running surface to create a path of least electrical resistance through the tread cap rubber layer;

wherein both the rubber composition of the outer tread cap rubber layer and rubber composition of the rubber strip are comprised of at least one diene-based elastomer and contain less than 30 phr of rubber reinforcing carbon black and at least 40 phr of precipitated silica together with a silica coupling agent for the precipitated silica, and wherein the rubber composition of the rubber strip contains a dispersion of from about 0.5 to about 30, alternately from about 1 to about 10, and alternately from about 1 to about 3, phr of carbon nanotubes,

wherein the rubber composition of the tread cap rubber composition is exclusive of carbon nanotubes.

In one embodiment, the tread base rubber layer is unified with and is the same rubber composition as the rubber strip in a sense that they are extruded as one component with the tread base rubber composition also containing carbon nanotubes, a deficiency of rubber reinforcing carbon black and containing precipitated silica reinforcement together with a coupling agent for the precipitated silica. Therefore the rubber strip is unified with and thereby an extension of the tread base rubber layer.

In another embodiment, the tread base rubber layer contains at least 40 phr of rubber reinforcing carbon black without carbon nanotubes and thereby relies on the rubber reinforcing carbon black to promote electrical conductivity and to provide reinforcement for the tread rubber base layer. In this manner the rubber strip adjoins but not of the same rubber composition as the tread base rubber layer.

In one embodiment, the rubber strip provides a path of least electrical resistance through the tread cap rubber layer to its running surface.

In one embodiment, the rubber strip is a thin rubber strip in a sense that it has a width at the running surface of the tread cap rubber layer in a range of from about 1 to about 5, alternately in a range of 1 to about 3, millimeters.

In practice, the silica coupler for the precipitated silica contains a moiety reactive with hydroxyl groups (e.g. silanol groups) on the precipitated silica and another different moiety interactive with said diene-based elastomer(s).

In practice, said carbon nanotubes have an average diameter in a range of from about 5 to about 20 nanometers (nm) and an L/D (length over diameter ratio) in a range of from about 100 to about 1000.

A significant aspect of the invention is providing both the outer tread cap rubber composition and rubber strip with a deficiency of rubber reinforcing black in a sense of being of a typically insufficient concentration in the rubber compositions to promote significant electrical conductivity and to promote significant reinforcement for their rubber compositions.

Instead, both of the outer tread cap rubber layer and the rubber strip rely upon a dispersion of precipitated silica together with coupling agent for the precipitated silica to promote reinforcement for their rubber compositions.

In this manner, then, the rubber compositions for both the tread cap rubber layer and rubber strip are similar in the sense of their rubber reinforcing carbon black and precipitated silica reinforcement contents (particularly a deficiency of rubber reinforcing carbon black contents) where they meet, or become, a running surface of the tire tread.

In practice, various diene-based elastomers may be used for the rubber composition of said tread strip such as, for example, polymers and copolymers comprised of at least one monomer comprised of at least one of isoprene and 1,3-butadiene and from styrene copolymerized with at least one of isoprene and 1,3-butadiene.

Representative of such conjugated diene-based elastomers are, for example, comprised of at least one of cis 1,4-polyisoprene (natural and synthetic), cis 1,4-polybutadiene, styrene/butadiene copolymers (aqueous emulsion polymerization prepared and organic solvent solution polymerization prepared), medium vinyl polybutadiene having a vinyl 1,2-content in a range of about 15 to about 90 percent, isoprene/butadiene copolymers, styrene/isoprene/butadiene terpolymers. Tin coupled elastomers may also be used, such as, for example, tin coupled organic solution polymerization prepared styrene/butadiene copolymers, isoprene/butadiene copolymers, styrene/isoprene copolymers, polybutadiene and styrene/isoprene/butadiene terpolymers.

In one aspect, the conjugated diene-based elastomer may be an elastomer such as, for example, styrene/butadiene copolymer containing at least one functional group reactive with hydroxyl groups on a precipitated silica such as, for example, comprised of at least one of siloxy, amine and imine groups.

Commonly employed synthetic amorphous silica, or siliceous pigments, used in rubber compounding applications can be used as the precipitated silica in this invention.

In practice, the precipitated silica employed in this invention are typically aggregates obtained by the acidification of a soluble silicate, e.g., sodium silicate and may include coprecipitated silica and a minor amount of aluminum.

Such precipitated silicas might be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, (1938), as well as ASTM D5604 for precipitated silica.

The silica may also be typically characterized, for example, by having a dibutylphthalate (DBP) absorption value in a range of about 50 to about 400 cc/100 g, and more usually about 100 to about 300 cc/100 g (ASTM D2414).

Various commercially available precipitated silicas may be considered for use in this invention such as, only for example herein, and without limitation, silicas from PPG Industries under the Hi-Sil trademark with designations Hi-Sil 210, Hi-Sil 243, etc; silicas from Rhodia as, for example, Zeosil 1165MP and Zeosil 165GR, silicas from Degussa AG with, for example, designations VN2 and VN3, as well as other grades of silica, particularly precipitated silicas, which can be used for elastomer reinforcement.

Various coupling agents, as previously mentioned, may be used if desired to aid in coupling the precipitated silica to the diene-based elastomer(s) in the rubber compositions.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing fillers materials such as, for example, the aforementioned rubber reinforcing carbon black and precipitated silica. As known to those skilled in the art, depending on the intended use of the sulfur vulcanizable and sulfur vulcanized material (rubbers), the additives mentioned above are selected and commonly used in conventional amounts.

Typical amounts of tackifier resins, if used, may, for example, comprise about 0.5 to about 10 phr, usually about 1 to about 5 phr. Typical amounts of processing aids, if used, may comprise, for example from about 1 to about 50 phr. Such processing aids can include, for example and where appropriate, aromatic, napthenic, and/or paraffinic processing oils. Typical amounts of antioxidants where used may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants, where used, may comprise for example about 1 to 5 phr. Typical amounts of fatty acids, if used, which can include stearic acid and combinations of stearic acid with one or more of palmitic acid oleic acid and may comprise, for example, from about 0.5 to about 3 phr. Typical amounts of zinc oxide may comprise, for example, from about 1 to about 10 phr. Typical amounts of waxes, such as for example microcrystalline waxes, where used, may comprise, for example, from about 1 to about 5 phr. Typical amounts of peptizers, where used, may comprise, for example, from about 0.1 to about 1 phr.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Conventionally, the sulfur vulcanizing agent is elemental sulfur. As known to those skilled in the art, sulfur vulcanizing agents may be used, for example, in an amount ranging from about 0.5 to about 4 phr, or even, in some circumstances, up to about 8 phr.

Sulfur vulcanization accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging, for example, from about 0.5 to about 4, alternately about 0.8 to about 1.5 phr. In another embodiment, combinations of a primary and a secondary accelerator might be used with the secondary accelerator, where used, being usually used in smaller amounts (for example about 0.05 to about 3 phr) in order to activate and to improve the properties of the vulcanizate. Combinations of these accelerators might be expected to produce a synergistic effect on the final properties and are somewhat better than those produced by use of either accelerator alone. In addition, delayed action accelerators may be used, for example, which are not affected by normal processing temperatures but produce a satisfactory cure at ordinary vulcanization temperatures. Vulcanization retarders might also be used, where desired or appropriate. Suitable types of accelerators that may be used in the present invention may be, for example, amines, disulfides, guanidines, thioureas, thiazoles, thiurams, sulfenamides, dithiocarbamates and xanthates. Preferably, the primary accelerator is a sulfenamide. If a second accelerator is used, the secondary accelerator may be, for example, a guanidine, dithiocarbamate or thiuram compound.

The presence and relative amounts of the above additives are not considered to be an aspect of the present invention, unless otherwise indicated herein.

The mixing of the rubber composition can be accomplished by methods known to those having skill in the rubber mixing art. For example, the ingredients are typically mixed in at least two stages, namely, at least one non-productive stage followed by a productive mix stage. The final curatives are typically mixed in the final stage which is conventionally called the “productive” mix stage in which the mixing typically occurs at a temperature, or ultimate temperature, lower than the mix temperature(s) than the preceding non-productive mix stage(s). The rubber, and reinforcing fillers, including the exfoliated graphene platelets and alternative additional reinforcing fillers such as, for example precipitated silica and rubber reinforcing carbon black mixed in one or more non-productive mix stages. The terms “non-productive” and “productive” mix stages are well known to those having skill in the rubber mixing art.

While various embodiments are disclosed herein for practicing the invention, it will be apparent to those skilled in this art that various changes and modifications may be made therein without departing from the spirit or scope of the invention.

What is claimed is:

1. A tire having a circumferential rubber tread of a cap/base construction where said tread cap rubber layer is an outer tread rubber layer with a running surface for the tire and where said tread base rubber layer underlies said tread cap rubber layer;
wherein said rubber tread is comprised of an outer tread cap rubber layer with a tread running surface composed of an electrically resistive rubber composition which contains a electrically conductive thin rubber strip extending radially outward from an underlying tread base rubber layer through the outer tread cap rubber layer to its running surface to create a path of least electrical resistance through the tread cap rubber layer;
wherein both the rubber composition of the outer tread cap rubber layer and rubber composition of the rubber strip are comprised of at least one diene-based elastomer and contain less than 30 phr of rubber reinforcing carbon black and at least 40 phr of precipitated silica together with a silica coupling agent for the precipitated silica, and
wherein the rubber composition of the rubber strip contains a dispersion of from about 0.5 to about 30 phr of carbon nanotubes, and
wherein the rubber composition of the tread cap rubber composition is exclusive of carbon nanotubes.

2. The tire of claim 1 wherein the tread base rubber layer is the same rubber composition as the rubber strip in a sense that they are extruded as one component with the tread base rubber composition also containing carbon nanotubes, less than 30 phr of rubber reinforcing carbon black and containing at least 40 phr of precipitated silica reinforcement together with a coupling agent for the precipitated silica.

3. The tire of claim 2 where the rubber strip is unified with and thereby an extension of the tread base rubber layer.

4. The tire of claim 1 wherein the tread base rubber layer contains at least 40 phr of rubber reinforcing carbon black without carbon nanotubes and thereby relies on the rubber reinforcing carbon black to promote electrical conductivity and to provide reinforcement for the tread rubber base layer.

5. The tire of claim 4 wherein the rubber strip adjoins and is not of the same rubber composition as the tread base rubber layer.

6. The tire of claim 1 wherein the silica coupler for the precipitated silica contains a moiety reactive with hydroxyl groups on the precipitated silica and another different moiety interactive with said diene-based elastomer(s).

7. The tire of claim 1 wherein the said carbon nanotubes have an average diameter in a range of from about 5 to about 20 nanometers (nm) and an L/D in a range of from about 100 to about 1000.

8. The tire of claim 1 wherein said diene-based elastomer is comprised of at least one polymer of at least one monomer selected from isoprene and 1,3-butadiene and from styrene copolymerized with at least one of isoprene and 1,3-butadiene.

9. The tire of claim 1 wherein at least one of said diene-based elastomer(s) is least one of tin coupled organic solution polymerization prepared styrene/butadiene co-polymers, isoprene/butadiene copolymers, styrene/isoprene copolymers, polybutadiene and styrene/isoprene/butadiene terpolymers.

10. The tire of claim 1 wherein said diene-based elastomer contains at least one functional group reactive with hydroxyl groups on a precipitated silica wherein said functional group is comprised of at least one of siloxy, amine and imine groups.

11. The tire of claim 1 wherein the rubber strip is a thin rubber strip in a sense that it has a width at the running surface of the tread cap rubber layer in a range of from about 1 to about 5 millimeters.

12. The tire of claim 1 wherein said rubber strip provides a path of least electrical resistance through the tread cap rubber layer to its running surface.
